(19) United States
(12) Patent Application Publication
(10) Pub. No.: US 2026/0273465 A1
(43) Pub. Date: Sep. 17, 2026

(54) Redox with Relative Hydrogen Sensors and Method

(71) Applicant: Streamline Innovations Inc, SAN ANTONIO, TX (US)

(72) Inventors: Franklin Hailey Brown, II, San Antonio, TX (US); Peter J. Photos, Boerne, TX (US); Cameron Nicolas Lee, San Antonio, TX (US); Dylan Todd Flesch, San Antonio, TX (US)

(21) Appl. No.: 19/671,582

(22) Filed: May 8, 2026

Related U.S. Application Data
(63) Continuation of application No. PCT/US25/51469, filed on Oct. 17, 2025.
(60) Provisional application No. 63/711,656, filed on Oct. 24, 2024.

(51) Int. Cl. B01D 53/78; B01D 53/34; B01D 53/79

(52) U.S. Cl. CPC B01D 53/78; B01D 53/346; B01D 53/79; B01D 2257/304; B01D 2257/504; B01D 2257/702; B01D 2259/124

(57) ABSTRACT

A gas treatment system may include a reduction unit, oxidation unit, sulfur removal unit, aqueous metal chelant stream and an rH sensor. The reduction unit may contact an influent gas stream with an aqueous metal chelant stream and release a treated gas stream separate from the aqueous metal chelant stream. The oxidation unit may be downstream of the reduction unit, and the oxidation unit may contact an oxidation stream with the aqueous metal chelant stream. An aqueous metal chelant stream may circulate from the reduction unit to the oxidation unit and downstream of the oxidation unit through the sulfur removal unit to the reduction unit. A system may include an rH sensor operatively connected to the aqueous metal chelant stream.

### CROSS-REFERENCE TO RELATED APPLICATIONS

This international patent application claims the benefit of priority under 35 U.S.C. § 119 (e) to U.S. Provisional Patent Application No. 63/711,656, filed on Oct. 24, 2024, titled “Redox with Relative Hydrogen Sensors and Method” the entire contents of which are incorporated herein by reference.

### BACKGROUND OF THE DISCLOSURE

### 1. Field of the Disclosure

The present invention relates to a gas purification and processing apparatus and method including the use of relative hydrogen (“rH”) sensors. More specifically, it relates to an apparatus and method of gas purification utilizing a reduction oxidation (“redox”) system including sensors to measure rH, potential hydrogen (“pH”), and oxidation reduction potential (“ORP”) and to control the chemical processes and balance the reactions within the reduction unit.

### 2. Description of the Related Art

Redox systems may be used in a variety of applications and involve contacting a reagent including a metal chelant formed of chelating agent and a metal, to remove contaminants from influent fluid streams. For example, in the energy sector, redox may be used to purify methane (“CH₄”) from sources such as biogas, landfill, natural gas extracted from wells, and refining by-products. In these cases, the influent fluid stream is a gas that may contain CH₄ as well as hydrogen sulfide which is a highly toxic contaminant that must be removed before CH₄ may be utilized for energy production.

During redox processes, a reagent including the metal chelant contacts the influent gas stream in a reduction unit. As a result, the hydrogen sulfide is treated through a reaction with the metal chelant, forming of elemental sulfur. Once the metal chelant contacts the hydrogen sulfide, the metal chelant becomes unavailable for further removal of hydrogen sulfide from the influent gas stream. Therefore, unless available metal chelant is added to the contactor, the ability of the reagent stream within the contactor to treat hydrogen sulfide decreases overtime. To increase efficiency and decrease costs, the reagent stream is typically regenerated in an oxidation unit downstream of the contacting unit, also referred to as a regeneration unit. Then, the reagent stream is recirculated to the contactor for additional treatment of hydrogen sulfide.

To meet the treatment goal for the concentration of hydrogen sulfide in the purified CH₄ gas stream, the reagent stream must include a high enough concentration of available metal chelant and have an adequate residence time within the reduction unit. However, operational costs arise from oxidizing unavailable metal chelant in the reagent stream and circulating the reagent stream from the oxidation unit to the reduction unit. For example, electricity is required to pump the reagent stream from the oxidation unit to the reduction unit and to blow or inject the oxidizing stream to the oxidation unit. Also, the more equipment like pumps and blowers are utilized, the more frequently maintenance intervention is required. Therefore, the efficiency of the redox system as well as the purification of CH₄ from the incoming gas stream is dependent on optimizing the circulation of reagent and regenerating the proper levels of available metal chelant.

Conventional methods of optimizing redox system controls are inadequate because measurements cannot be performed in real-time and/or require laboratory testing outside of the redox system. For example, inlet H₂S concentration and flow rate may be monitored to estimate the average injection required of an oxidating agent based on a stoichiometric balance to restore the unavailable reagent to its initial state. However, operational delays exist between the inlet stream sample measurements and residence time of the reagent as it circulates between the reduction and oxidation unit. These delays, which are attributed to the H₂S concentration measure and the residence times inherent in the designs of the units, promote process control instabilities and poor optimization if using the stoichiometric balance of the reactants.

Another example of a conventional redox control parameter includes the change in pH of the reagent stream measured over time at a point in the system. This leads to inefficient control because pH changes with the temperature. Without compensating for temperature, the resultant noise in the measurement would result in poor control and high inefficiencies. Also, the pH measurement is time-based, adding further delays to the redox system and increasing control instability.

ORP measurement of the reagent stream is another example of control factors that can lead to inefficiencies if inaccurate. ORP is dependent on many different factors including temperature. However, temperature is one of the most variable within a redox unit. As a result, ORP measurement without temperature compensation does not always provide an accurate value from which to adjust operational parameters.

Another method of control applicable to iron-based metal chelants includes measuring the amount of ferric iron vs cumulative soluble iron (ferric+ferrous). This measurement requires laboratory facilities and time to perform testing procedures. Also, sample collection and handling with this testing method is susceptible to contamination. Once again an inconvenient time delay exists between the time the sample is taken and the ability to alter redox conditions.

In view of the time delays, inaccurate reactant mass balances, and difficulty maintaining a constant temperature and pH, the conventional methods of control of a redox unit can compound errors leading to inefficient operation and the costly degradation of the redox reagent stream. Therefore, there is a need for an improved redox unit and method including sensors for real time monitoring and control of the available state of the reagent in the system

### BRIEF SUMMARY OF THE DISCLOSURE

The gas treatment system and method of operating the gas treatment system, according to this disclosure, includes at least one rH sensor, pH and ORP sensor or individual pH and ORP sensors to overcome the challenges of chemical process control in redox treatment systems. More specifically, an rH sensor, combined pH and ORP sensor or individual pH and ORP sensors may be placed on the metal chelant stream that circulates throughout the redox system. The sensed values for pH and ORP may be utilized to determine the rH in real-time. Without delay, control of the gas treatment system may be performed based on the rH value. For example, the rH value may be utilized as a basis to change or control the circulated volumes the metal chelant stream flowing through the system, the injected mass rate of the oxidation stream, and/or the flowrate of the purified or treated gas stream.

Utilizing the rH for chemical process control of redox system has several benefits. First, if an rH probe is utilized, the rH value may be obtained in real-time from a single electrode. This allows the measurements to be taken from one point in a stream and eliminates the problems of time and distance delay between measurements. Second, rH is based in part on pH which allows H to account for any difficulty in controlling the conditions and/or temperature of the system to maintain a constant pH. Third, as the use of the rH value of the metal chelant stream allows for an accurate measurement of the reducing ability of the stream, allowing for more efficient operation. For example, the pump speed associated with circulating the stream may be increased, decreased or powered off or on rather than being constantly powered on at a less than optimum rate. Similarly, the flow rate of the injected oxidating agent to the oxidation unit may be increased or decreased as any blower or pump may be modulated or powered on-off as needed. These changes in flowrate allow for conservation of metal chelant as well as energy, and equipment.

In some aspects, the techniques described herein relate to a gas treatment system including: a reduction unit configured to contact an influent gas stream with a metal chelant stream and release a treated gas stream separate from the metal chelant stream; an oxidation unit downstream of the reduction unit, the oxidation unit configured to contact an oxidation stream and the metal chelant stream and release the metal chelant stream; the metal chelant stream circulated from the reduction unit to the oxidation unit and the metal chelant stream circulated from the oxidation unit to the reduction unit; a pH sensor and an ORP sensor operatively connected to the metal chelant stream, the pH sensor configured to provide a pH value of the metal chelant stream and the ORP sensor configured to provide an ORP value of the metal chelant stream; and a transmitter connected to the pH sensor and the ORP sensor, the transmitter configured to determine an rH value, based on the pH value and ORP value, of the metal chelant stream.

In some aspects, the techniques described herein relate to a system, further including: an integrated electrode including the pH sensor and ORP sensor.

In some aspects, the techniques described herein relate to a system, wherein the metal chelant stream further includes: a metal chelant, metal chelants, ferric salts, ferrous salts, ferric chelants, ferrous chelants, nano-iron, colloidal iron, Fe-MGDA, HEME, organisms containing HEME, or a combination thereof.

In some aspects, the techniques described herein relate to a system, wherein the oxidation unit includes: an oxidation agent injector configured to provide the oxidation stream to the oxidation unit at an oxidation stream rate; an oxidation controller connected to the oxidating agent injector and operably connected to the transmitter, the oxidation controller configured to receive the rH value from the transmitter, and the oxidation provider controller configured to change the oxidation stream rate based on the rH value.

In some aspects, the techniques described herein relate to a system, further including: a pump connected to the metal chelant stream, the pump configured to provide the metal chelant stream to the reduction unit at a pump speed; and a pump controller operatively connected to the pump and the transmitter, the pump controller configured to receive the rH value from the transmitter and the pump controller configured to change the pump speed based on the rH value.

In some aspects, the techniques described herein relate to a system, wherein the sensor is operatively connected to the metal chelant stream between the reduction unit and the oxidation unit.

In some aspects, the techniques described herein relate to a system, wherein the sensor is operatively connected to the metal chelant stream, the sensor being downstream of the oxidation unit and upstream of the reduction unit.

In some aspects, the techniques described herein relate to a system, wherein the influent gas stream includes hydrogen sulfide, hydrocarbon gas, carbon dioxide or any combination thereof.

In some aspects, the techniques described herein relate to a system, wherein the reduction unit includes an eductor, co-current contactor, countercurrent contactor or co-current and countercurrent contactor configured to contact the influent gas stream with the metal chelant stream and release the treated gas stream separate from the metal chelant stream.

In some aspects, the techniques described herein relate to a system, wherein the oxidation unit includes co-current bubble contactor or countercurrent packed tower.

In some aspects, the techniques described herein relate to a system, wherein the oxidating agent injector is a blower configured to provide a gaseous oxidation stream to the oxidation unit or the oxidating agent injector is a pump configured to provide an aqueous oxidation stream to the oxidation unit.

In some aspects, the techniques described herein relate to a gas treatment system including: a reduction unit configured to contact an influent gas stream with an metal chelant stream and release a treated gas stream separate from the metal chelant stream; an oxidation unit downstream of the reduction unit, the oxidation unit configured to contact an oxidation stream and the metal chelant stream; the metal chelant stream circulated from the reduction unit to the oxidation unit and from downstream of the oxidation unit to the reduction unit; and an rH sensor operatively connected to the metal chelant stream, the rH sensor configured to generate and rH value of the metal chelant stream.

In some aspects, the techniques described herein relate to a system, wherein the metal chelant stream further includes: a metal chelant, metal chelants, ferric salts, ferrous salts, ferric chelants, ferrous chelants, nano-iron, colloidal iron, Fe-MGDA, HEME, organisms containing HEME, or a combination thereof.

In some aspects, the techniques described herein relate to a system, further including: a pump connected to the metal chelant stream, the pump positioned downstream of the oxidation unit, the pump configured to circulate, at a pump speed, the metal chelant stream to the reduction unit; and a pump controller operatively connected to the rH sensor and the pump, the pump controller configured to receive the rH value from the rH sensor, and the pump controller configured to change the pump speed based on the rH value.

In some aspects, the techniques described herein relate to a system, wherein the oxidation unit includes: an oxidating agent injector operatively connected to the oxidation unit, the oxidating agent injector configured to provide the oxidation stream, at an oxidation stream rate, to the oxidation unit; and an oxidation controller operatively connected to the rH sensor and the oxidating agent injector, the oxidation controller configured to receive the rH value from the rH sensor, and the oxidation controller configured to change the oxidation stream rate based on the oxidating agent injector.

In some aspects, the techniques described herein relate to a system, wherein the metal chelant stream released from the reduction unit is a reduced metal chelant stream flowing from the reduction unit to the oxidation unit, and the rH sensor is operatively connected to the reduced metal chelant stream.

In some aspects, the techniques described herein relate to a system, wherein the rH sensor is operatively connected to the metal chelant stream, the rH sensor being downstream of the oxidation unit and upstream of the reduction unit.

In some aspects, the techniques described herein relate to a system, wherein the influent gas stream includes hydrogen sulfide, hydrocarbon gas, carbon dioxide or any combination thereof.

In some aspects, the techniques described herein relate to a system, wherein the reduction unit is a co-current contactor, countercurrent contactor or co-current and countercurrent contactor configured to contact the influent gas stream with the metal chelant stream and release the treated gas stream separate from the metal chelant stream.

In some aspects, the techniques described herein relate to a system, wherein the oxidation unit includes co-current bubble contactor or countercurrent packed tower.

In some aspects, the techniques described herein relate to a system, wherein the oxidating agent injector is a blower configured to provide a gaseous oxidation stream to the oxidation unit or the oxidating agent injector is a pump configured to provide an aqueous oxidation stream to the oxidation unit.

In some aspects, the techniques described herein relate to a method of operating a gas treatment system including: operating a reduction oxidation unit including a reduction unit configured to contact an influent gas stream with a metal chelant stream and release a treated gas stream separate from the metal chelant stream; and an oxidation unit downstream of the reduction unit, the oxidation unit configured to contact an oxidation stream and the metal chelant stream; circulating the metal chelant stream from the reduction unit to the oxidation unit and from downstream of the oxidation unit to the reduction unit; measuring, via a pH sensor and an ORP sensor, a pH value and an ORP value of the metal chelant stream; and determining an rH value, via a transmitter, operatively connected to the pH sensor and the ORP sensor, based on the pH value and ORP value, of the metal chelant stream.

In some aspects, the techniques described herein relate to a method, further including: using a pH and ORP electrode, including the pH sensor and ORP sensor, to measure the pH value and the ORP value of the metal chelant stream.

In some aspects, the techniques described herein relate to a method, wherein measuring, via a pH sensor and an rH sensor, a pH value and an ORP value of the metal chelant stream further includes: measuring the pH value and the ORP value at a point within the metal chelant stream.

In some aspects, the techniques described herein relate to a method, wherein measuring the pH value and the ORP value at a point within the metal chelant stream further includes: measuring, simultaneously, the pH value and the ORP value of the metal chelant stream.

In some aspects, the techniques described herein relate to a method, further including: using a pump to circulate, at a pump speed, the metal chelant stream from downstream of the oxidation unit to the reduction unit; receiving the rH value, via a pump controller; and changing the pump speed, via the pump controller, based on the rH value.

In some aspects, the techniques described herein relate to a method, further including: providing the oxidation stream to the oxidation unit at an oxidation stream rate; and changing the oxidation stream rate on the rH value.

In some aspects, the techniques described herein relate to a method, wherein circulating the metal chelant stream further includes: circulating the metal chelant stream including a metal chelant, metal chelants, ferric salts, ferrous salts, ferric chelants, ferrous chelants, nano-iron, colloidal iron, Fe-MGDA, HEME, organisms containing HEME, or a combination thereof.

In some aspects, the techniques described herein relate to a method of operating a gas treatment system including: operating a reduction oxidation unit including a reduction unit configured to contact an influent gas stream with an metal chelant stream and release a treated gas stream separate from the metal chelant stream; and an oxidation unit downstream of the reduction unit, the oxidation unit configured to contact an oxidation stream and the metal chelant stream; circulating the metal chelant stream from the reduction unit to the oxidation unit and from downstream of the oxidation unit to the reduction unit; and measuring rH value of the metal chelant stream at a point within the metal chelant stream.

In some aspects, the techniques described herein relate to a method, wherein circulating the metal chelant stream from the reduction unit to the oxidation unit and from downstream of the oxidation unit to the reduction unit further includes: using a pump to circulate, at a pump speed, the metal chelant stream from downstream of the oxidation unit to the reduction unit; and controlling the pump speed based on the rH value.

In some aspects, the techniques described herein relate to a method, further including: providing the oxidation stream to the oxidation unit at an oxidation stream rate; and changing the oxidation stream rate based on the rH value.

In some aspects, the techniques described herein relate to a method, wherein measuring rH value of the metal chelant stream at a point within the metal chelant stream further includes: using an rH sensor including a pH and ORP combined electrode to measure a rH value at the point within the metal chelant stream.

In some aspects, the techniques described herein relate to a method, wherein circulating the metal chelant stream further includes: circulating the metal chelant stream including a metal chelant, metal chelants, ferric salts, ferrous salts, ferric chelants, ferrous chelants, nano-iron, colloidal iron, Fe-MGDA, HEME, organisms containing HEME, or a combination thereof.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 a schematic diagram of a first embodiment of redox unit according to this disclosure;

FIG. 2 is a schematic diagram of a second embodiment of a redox unit according to this disclosure;

FIG. 3 depicts an electrode of an rH sensor within the redox unit of FIG. 1 according to this disclosure;

FIG. 4 is a flow diagram of a method, according to this disclosure, of utilizing rH sensors for chemical process control of a redox unit.

### DETAILED DESCRIPTION OF THE INVENTION

Certain terminology is used in the following description for convenience only and is not limiting. As used herein, the words “connected” or “coupled” are each intended to include integrally formed members, direct connections between two distinct members without any other members interposed therebetween and indirect connections between members in which one or more other members are interposed therebetween. The terminology includes the words specifically mentioned above, derivatives thereof, and words of similar import.

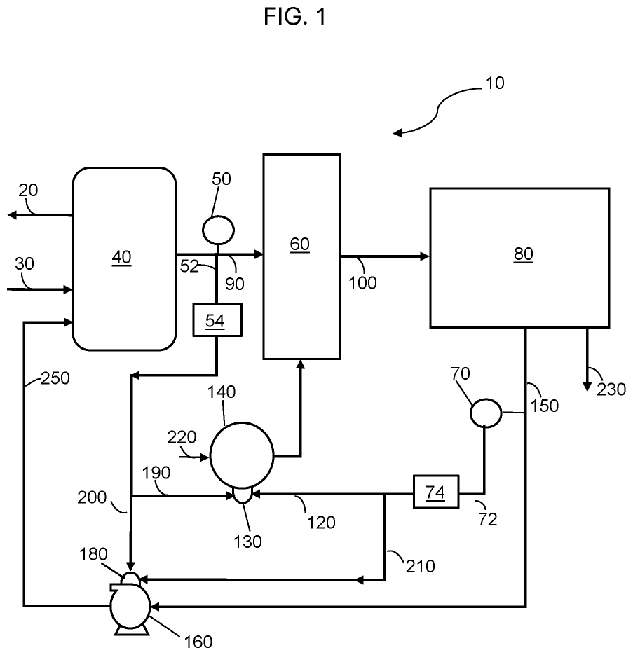

Referring now to the drawings in detail, wherein like numbers are used to indicate like elements throughout, FIGS. 1-4 depict embodiments of redox gas treatment units including rH and/or pH and ORP sensors that allow for efficient chemical process control of the redox system. FIG. 1 depicts a first embodiment of a redox gas treatment system 10 including influent gas stream 30, reduction unit 40, regeneration or oxidation unit 60, sensor transmitters 54, 74, stream sensors 50, 70, desulfurization unit 80, oxidation controller 130, oxidizing agent injector 140, pump controller 180, pump 160, oxidation stream 220 and control signal 120, 190, 200, 210 and metal chelant stream 250.

Influent gas stream 30 may be any gas including H₂S such as sour gas and may result from various sources including natural gas extracted from a well, biogas, landfill gas, industrially produced gases and oil refining gases, etc. Due to the range of sources, stream 30 may include hydrocarbons such as those commonly found in natural gas while also containing CO₂, metals, water vapor, and other fluids contaminated with H₂S.

Metal chelant stream 250 is an aqueous solution including a metal chelant that acts as a reducing agent in the reduction unit 40 and is capable of being oxidized in regeneration unit 60. Stream 250 circulates throughout system 10 in various forms including desulfurized metal chelant stream 150 flowing from desulfurization unit 80 to reduction unit 40, reduced stream 90 flowing from the reduction unit 40 to regeneration unit 60 and regenerated stream 100 flowing from regeneration unit 60 to desulfurization unit 80. As both streams 100 and 150 are downstream of regeneration unit 60, streams 100, 150 include regenerated metal chelant prepared for reuse in reduction unit 40.

A suitable metal chelant may include one or more of ferric salts, ferrous salts, ferric chelants, ferrous chelants, nano-iron, colloidal iron, Fe-MGDA (ferric/ferrous methylglycinediacetate) such as Alanine, n,n-bid, (carboxymethyl) iron complex (CAS 547763-83-7), natural heme separated from natural organisms, whole organisms such as bacteria or yeast which include heme, and biosynthesized heme, etc. If the metal chelant includes biosynthesized heme, a metallic porphyrin, such as iron porphyrins, may be preferred. Biosynthesized heme may be produced through recombinant DNA and genetic engineering of yeast. An example the biosynthesis of heme is described in U.S. Pat. Nos. 9,938,327 and 10,689,656 issued Apr. 10, 2018 and on Jun. 23, 2020, respectively, both of which are entitled “Expression Constructs and Methods of Genetically Engineering Methylotrophic Yeast”, and the contents of both applications are herein incorporated by reference in their entirety.

Reduction unit 40 is a contactor in which both influent gas stream 30 and metal chelant stream 150 are contacted generating a purified gas stream 20 and a reduced metal chelant stream 90. Preferably, reduction unit 40 is a co-current and countercurrent contactor (“CC contactor”) or a CC contactor including an air stripper. Both contactors are disclosed in U.S. patent application Ser. No. 17/552,727 filed on Dec. 16, 2021, entitled “Co-current and Countercurrent Contactor for Immiscible Fluids” the contents of which are herein incorporated by reference in their entirety. Other suitable reduction units include 40 contactors configured to contact stream 30 and stream 150 through either co-current contactor (e.g. bubble column), countercurrent contactor (e.g. scrubber or stripper) or any combination thereof. Further, reduction unit 40 may incorporate one or more eductors as disclosed in U.S. patent application Ser. Nos. 18/740,982, 18/741,115 entitled “Gas Purification Apparatus with Eductors”, the entire contents of which are herein incorporated by reference.

When aqueous metal chelant stream 250 contacts influent gas stream 30 including H₂S, the sulfide ions in the H₂S react and combine to form elemental sulfur and the metal chelant is reduced. For example, if an iron chelate is utilized as the metal chelant in stream 250, a reaction occurs as follows:

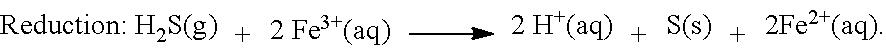

As a result, the H₂S is removed from the influent stream 30 and purified or treated gas stream 20 is released. The constituents of gas stream 20 depend on the constituents of influent gas stream 30. For example, if influent stream 30 natural gas contaminated with H₂S, consequently classified as sour, the purified or treated gas stream 20 will be sweet natural gas, which may be suitable for energy generation, other process treatment and/or compression and transportation the gas. Alternatively, if the influent stream 30 is a tail gas such as from an amine unit, the purified gas stream would be CO₂.

Reduced metal chelant stream 90 is the aqueous effluent stream of reduction unit 40 and is received by regeneration unit 60. Stream 90 includes elemental sulfur as well as reduced metal chelant. The reduced metal chelant is unavailable for further contacting with H,S and must be regenerated to become available for reuse.

To regenerate the reduced or unavailable chelant, regeneration unit 60 oxidizes reduced metal chelant stream 90 by contacting stream 90 with oxidation stream 220. Oxidation stream 220 includes an oxidizing agent such as a solution of sodium percarbonate, inorganic peroxides (i.e., hydrogen peroxide, calcium peroxide, and magnesium peroxide), sodium persulfate, sodium chlorite, one or more of chlorine, hypochlorous acid, hypochlorite, chlorine dioxide, chlorite, perchlorate, permanganates, sodium, air, oxygen, and/or ozone. Oxidation stream 220 may be pumped or blown into unit 60 via oxidizing agent injector 140. That is, injector 140 includes a pump if oxidation stream 220 is aqueous such as hydrogen peroxide, while other applicable apparatuses for injector 140 include a blower if oxidation stream 220 is gaseous such as air. A suitable regeneration unit 60 may include a co-current bubble column or countercurrent packed tower, etc.

Within regeneration unit 60, oxidation stream 220 mixes with reduced metal chelant stream 90 and if an iron chelate was used, the iron is oxidized so that it is regenerated and now available for further reaction in reduction unit 40. For example, a reaction occurs as follows:

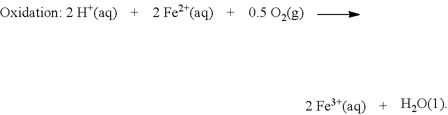

Although the iron is regenerated, stream 90 included elemental sulfur which may be removed partially or in whole prior to the regenerated metal chelant being returned to the reduction unit. 40.

Available stream 100 is the effluent of regeneration unit 60 and may move downstream to sulfur removal unit 80 which may include reagent storage along with various units to remove sulfur from stream 90. For example, unit 80 may include a filter press, centrifuge, dewatering box, and/or filter bags, etc. Unit 80 generates elemental sulfur stream 230 as well as regenerated metal chelant stream 150 which is an available metal chelant stream. As a result, stream 150 is ready for use in reduction unit 40.

Pump 160 circulates stream 150 from desulfurization unit 80 to reduction unit 40. Pump 160 may be a centrifugal or vertical pump or any other suitable pump.

System 10 includes one or more rH sensors 50, 70 connected to stream 250 as well as respective transmitters 54, 74 via control signal lines 52, 72. Sensors 50, 70 may be rH sensors and/or combined pH sensor and ORP sensor for acquiring the data necessary for determining the rH value of stream entering and leaving unit 40. Although sensor 70 is depicted on stream 150, the available state of the reagent and measurable rH in streams 150 and 250 are the same. Sensor 50 is depicted directly on stream 90.

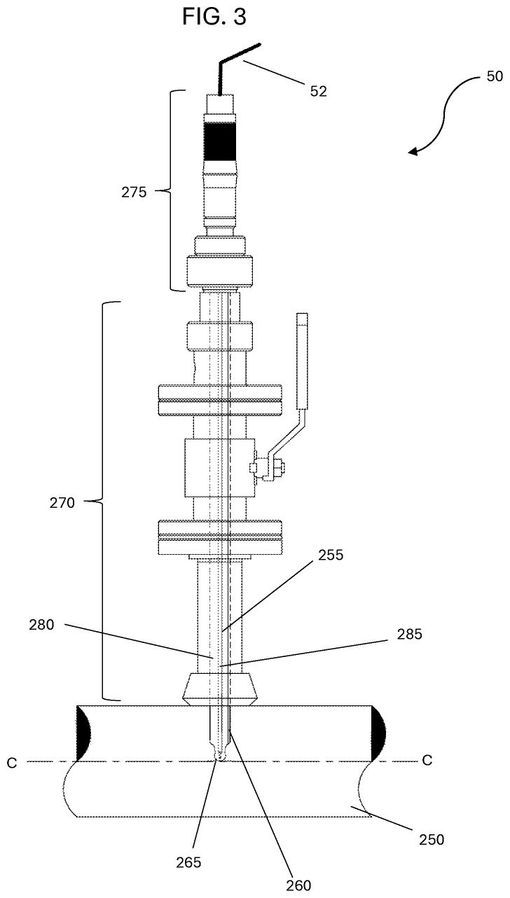

Preferably, sensor 50, 70 is an rH sensor and/or has a combined pH sensor and ORP sensor electrode i.e. an integrated electrode 280 (FIG. 3) allowing for simultaneous measurement of pH and ORP at a single point in stream 250 as well as real-time calculation of the rH value. Simultaneous pH and ORP measurements taken at the same point in stream 205 allow for the most accurate rH value to be calculated for the corresponding stream 90, 150, and 250 without time or distance delay between the pH and ORP measurements. As a result, a simultaneous, real-time rH value may be provided and instantaneous control measures may be taken,

FIG. 3 depicts an example of a suitable rH sensor 50 with combined pH and ORP electrode 280 inserted into stream 250. A glass sleeve 255 surrounds electrode 280 which includes both an ORP sensor 260, which may be a platinum plate for ORP measurements, and pH sensor 265 including a glass membrane as well as pH reference lead 285. Above stream 250, sensor 50 includes connector 275 and clamp and sleeve apparatus 270. Glass sleeve 255, as shown by the dashed lines, extends from apparatus 270 through the clamp and sleeve apparatus 270 into stream 250. Measurement signal cable 52 extends from connector 275 to transmitter 54 which may use the measured pH value and ORP value to calculate the rH value and transmitted the rH value to respective controller(s) 130, 170. Although the rH sensor is discussed relative to sensor 50, the above discussion is also applicable to sensor 70.

Transmitters 54, 74 receive the measured pH and ORP values for stream 250 from respective sensors, via measurement signal cables 52, 72 and calculate the rH values. Next, transmitters 54 communicate the rH values to controller 130 pertaining to oxidizing agent injector 140 and/or controller 180 pertaining to pump 160. Transmitter 54 may be operatively connected to pump controller 180 via control signal 200, and transmitter 54 may be operatively connected to oxidation controller 130 via control signal 190 which branches from signal 200. Also, transmitter 74 may be operatively connected to pump controller 180 via control signal 210, and transmitter 74 may be operatively connected to oxidation controller 130 via control signal 120 which branches from signal 210.

The rH value of stream 250 is an indicator of the oxidation or reducing ability of the metal chelant(s) within the measured stream 90, 150, 250. For example, rH values range from 0-42 and stream 250 will have relatively high reducing ability and low oxidation ability when the rH value is relatively high such as between 25-42. On the other end of the range, an rH value of 0-9 corresponds with a high oxidation ability and a very low reducing ability. As the rH value of stream 250 moves from 0 to 42, the trend continues of the reducing ability increasing and the oxidation ability decreasing. —. Finally, in the middle of the range, the reducing and oxidation ability are balanced in the range of rH 9-25.

As rH is a measure of the reducing ability of stream 250, controller 130 may use rH values to efficiently control oxidation in regeneration unit 60. When controllers 130 receive low rH value from either transmitter 54 or 74, controller 130 may increase the speed oxidizing agent injector 140 or power on injector140 to increase the oxidation stream 220 flow rate into the regeneration unit 60. This action helps ensure the injected mass of the oxidizing agent is sufficient to regenerate the reduced or unavailable metal chelant in stream 90. Conversely, in response to a high rH value, controller 130 may decrease input of oxidizing stream 220 or even power off injector 140. This accounts for the situation that the metal chelant stream does not require much regeneration at this time. For feedforward control, the rH value may be measured, via sensor 50, before regeneration unit 60. For feedback control, the rH may be measured via sensor 70 downstream of unit 60 in streams 150 and/or 250. As a result, the oxidation process in regeneration unit 60 is better controlled and equipment, chelant and energy may be conserved.

Alternatively, measured rH values may be used as control parameters to increase the efficiency and/or control of reduction unit 40 by adjusting the speed of pump 160. If controller 180 receives a low rH value from either transmitter 54, 74, controller 180 may signal pump 160 to increase the speed of the metal chelant stream 150 provided to reduction unit 40. As a low rH value indicates stream 150 possesses weak reducing capabilities, the faster pump speed will increase the amount of chelant provided to reduction chamber and the amount of available reagent. Conversely, if controller 180 receives a high rH value indicating low reducing ability, from either transmitter 54, 74, controller 180 may decrease the speed of pump 160. As a result, less metal chelant would be provided to reduction unit 40 and the reducing ability of the metal chelant would be decreased avoiding excessive stream 250 circulation rate. As a result, system 10 is operated more efficiently promoting optimal contact in unit 40 and conserving both equipment wear, electricity, and resources such as the metal chelant stream 250.

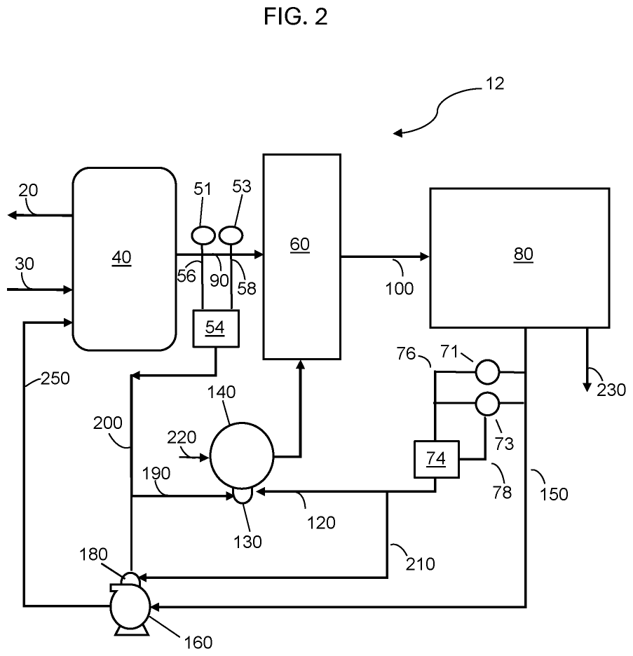

FIG. 2 depicts a second embodiment of a redox gas treatment system 12 including separate pH and ORP sensors 51, 53, 71, 73 rather than integrated or combined pH and ORP electrode 280. First pH sensor 51 and first ORP sensor 53 are connected, via corresponding measurement signals 56, 58 to transmitter 54. Second pH sensor 71 and second ORP sensor 73 are connected, via corresponding measurement signals 76, 78 to transmitter 54. When using separate pH and ORP sensors 51, 53, 71, 73, optimal measurements may be acquired when both the paired first pH and ORP sensors 51, 53 as well as second pH and ORP are placed, as shown, on the same stream 90, 150 or 250. This configuration allows rH to be calculated, via corresponding transmitter 54, 74, based on pH and ORP measurements. Due to the chemistry changes of reduction reaction in reduction unit 40 and oxidation reaction in regeneration unit 60, it is preferable that both pH and ORP values be measured for either stream 90 or stream 150. That is, first pH sensors 51 and first ORP sensor 53 generate first pH and first ORP values and second pH sensor 71 and second ORP sensor 73 generate second pH and second ORP values. Control based on rH is possible even when first pH sensor 51 and first ORP sensor 53 are placed on different stream segments such as 90 and 100 or 90 and 150. Similarly, second pH sensor 71 and second ORP sensor 73 may be placed on different segments of stream 250.

Control signals120, 190, 200, 210 may be wired or wireless communications such as short-range wireless technology or wireless fidelity (“Wi-Fi”). Measurement signals 52, 56, 58, 72, 76, 78 may be wired to the respecting transmitters 54, 74. Alternatively, sensors 50, 70 may be integrated with each respective transmitter 54, 74, eliminating measurement signal wires 52, 56, 58, 72, 76, 78.

Controllers 130, 180 may be integral of the respective pump 160 or oxidizing agent injector 140 or add-on equipment. In either case, controllers 130, 180 may communicate via wired or wireless connection(s) with the respective oxidation agent injector 1450 and/or pump 160. Suitable controllers include programmable logic controller (PLC) or remote terminal unit (RTU) modules in conjunction with variable frequency drives, resistors, throttling positioners or other similar control devices.

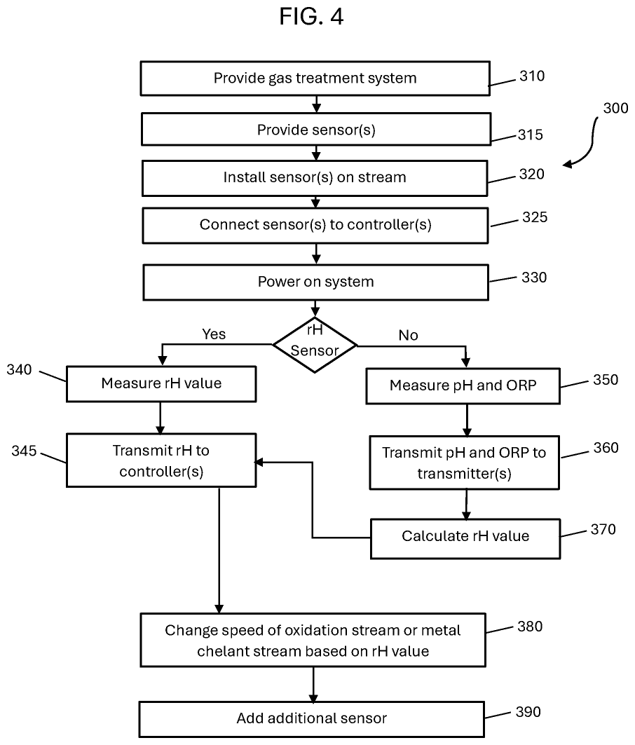

FIG. 4 depicts a method 300 of controlling a redox gas treatment system 10, 12 based rH of the metal chelant stream 250 as well as a method of making the redox system 10,12 with rH based controls. Initially, step 310, a redox system 10, 12 as described above is provided. Next in step 315, at least one sensor 50, 70, or pair of pH and ORP sensors 51, 53, 71, 73 is selected and provided. Preferably, at least one sensor 50, 70 is an rH sensor or a simultaneous pH and ORP sensor with a combination pH and ORP electrode 280. Alternatively, at least one pair of pH and ORP sensors 51, 53 and/or 71, 73 may be provided. For control based on the rH of stream 250 upstream of reduction unit 40 and downstream of oxidation unit 60, sensors 50 and 70 or 51, 53 and 71, 73 should be provided. This control scheme will allow control of the conditions in reduction unit 40 and oxidation unit 60 and may render more optimal control than using only one sensor.

In step 320, at least one sensor 50, 70 is installed on stream 250 in system 10, 12. For example, reduced stream rH sensor 50 may be placed on reduced stream 90 and/or available stream rH sensor 70 may be placed on available metal chelant stream 150 or regenerated stream 250. Alternatively, as shown in FIG. 2, first pH sensor 51 and first ORP sensor 53 and/or second pH sensor 71 and second ORP sensor 73 may be placed in system 10, 12. Each sensor 50, 70, 51, 53, 71, 73 should be installed such that electrode 280 or other sensing component may contact the aqueous metal chelant stream 90, 150, 25050.

As shown in FIG. 3, electrode 280 extends from the top of stream 250 to centerline C-C. However, electrode 280 may be above or below centerline C-C as long as electrode 280 may make contact with stream 250 and is not so low that, sediment in the conduit can impede sensing accuracy. While this discussion of installing sensor 50, 70 into stream 250 is based on combined pH and ORP electrode 280 within stream 250, it is applicable to separate pH and ORP sensor 51, 53, 71, 73, also.

As far as the installation locations on stream 250, initial sensor 50, 70, 51, 53, 71, 73 may be chosen based on the treatment needs as understood before treating has begun. For example, if influent stream 30 includes a substantially constant volumetric flowrate with a constant concentration of H₂S, then monitoring the effectiveness of oxidation unit 60 may be desired and sensor 70 may be initially used. On the other hand, if the influent gas stream 30 includes a variable flow rate and/or variable concentration of H₂S, then sensor 50 may be desired as sensor 50 would allow relatively closer monitoring of unit 40. Also, utilizing both sensors 50 and 70 or sensors 51, 53, 71, 73 may also be preferable. This allows control of both the regeneration unit 60 and the reduction unit 40 based on the upstream and downstream rH data.

In step 325, each sensor 50, 70, 51, 53, 71, 73 is connected to the respective transmitter 54, 74, if necessary. Also, each transmitter 54, 74 may be connected to controllers 130, 180.

In step 330, system 10, 12 is powered on and treatment of influent gas stream begins as well as the circulation of metal chelant stream 250 through system 10, 12. Once operation of system 10, 12 begins, the measurement of pH and ORP may be performed based on the type of sensors 50, 70, 51, 53, 71, 73 being used.

If sensor(s) 50, 70 is an rH sensor, step 340 includes performing an rH measurement of stream 90,150,250 using sensor(s) 50 70. If combined pH and ORB electrode 280 is used as in the case of sensors 50, 70, the measurement will be performed simultaneously at the same point in stream 250.

If sensor 50, 70 renders a pH and ORP value, rather than rendering an rH value, or a pair of sensors 51, 53 or 71, 73 is utilized, step 350 includes measuring pH and ORP values of streams 90, 150, 250 and generating a first and/or second data set which each include the pH and ORP of the corresponding sensors 51, 53, 71, 73. On the other hand, if first sensors 51, 53 and/or 71, 73 are used, the measurements should be taken at the same time from stream 90, 150, 250. Preferably, each pH and ORP set 51, 53 and 71, 73 should be located in close proximity to each other, essentially by the minimum distance required to avoid any measurement inference or inaccuracy.

In step 360, sensor(s) 50, 70, 51, 53, 71, 73 transmit measured pH values and ORP values to corresponding transmitter 54, 74.

Step 370 includes calculating the rH value, via transmitter 54, 74, based on the measured pH and ORP values. The relationship between rH, pH and ORP may be defined by the following equation:

$$rH = ( ( ORP + 200 ) / 30 ) + ( 2 * pH ) .$$

Therefore, once the ORP and pH are received by transmitter 54, 74, the respective transmitter 54, 74 may calculate the corresponding rH value.

Now that the rH value is known for the corresponding stream 90, 150, 250, step 345, includes transmitting the rH value, via respective transmitter 54, 74, to controller 130 and/or 180.

In step 380, controller 130 and/or 180 adjusts corresponding oxidizing agent injector 140 and/or pump 160 based on the rH value. For example, if an rH value is lower than a target value, which may be a first target or predetermined value, controller 130 may increase the speed of oxidation agent injector 140 thereby increasing the flow rate of oxidation stream 220 into regeneration unit 60. Alternatively, when controller 130 receives an rH value higher than the same or another target value, which may be the second target or predetermined value, controller 130 may decrease oxidation agent injector 140 speed to increase the volumetric flow rate of oxidation stream 220 into oxidation in unit 60 increasing the rate of oxidation in regeneration unit 60.

In the case that controller 180 receives an rH value in the low or first range, controller 180 may increase pump speed of pump 160, increasing the rate of circulation of metal chelant stream 250 and allowing for available reagent to make contact in unit 40. Also, if controller 180 receives a low rH value, controller 180 may decrease pump speed of pump 160 to decrease the speed and volumetric flowrate of stream 250 so available chelant is provided to unit 40 may be more efficiently used.

For the range when the rH value is balanced between reducing and oxidation potential, controllers 130 and 180 may, preferably, modulate oxidation stream 220 and aqueous metal chelant stream 250, respectively, to maintain a target rH. The target value(s) may be set by the operator of system 10, 12. The determinations for these targets are based many factors such as the influent gas stream 30 composition and H₂S concentrations, operating conditions of the system, the size of the reduction unit 40 and oxidation unit 60 as well as the operational efficiency required of the system 10, 12.

In step 390, if only one sensor 50 or 70 was initially used, a second sensor 50 or 70 may be added to system 10, 12 for additional control.

It is noted that sensors 50, 51, 53 are shown on stream 90 and sensors 70, 71, 73 are shown on stream 150. However, sensor 50, 70, 51, 53, 71, 73 may also be positioned on stream 100 as stream 100 is part of stream 250.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

1. A gas treatment system comprising:
a reduction unit configured to contact an influent gas stream with a metal chelant stream and release a treated gas stream separate from the metal chelant stream;
an oxidation unit downstream of the reduction unit, the oxidation unit configured to contact an oxidation stream and the metal chelant stream and release the metal chelant stream;
the metal chelant stream circulated from the reduction unit to the oxidation unit and the metal chelant stream circulated from the oxidation unit to the reduction unit;
a pH sensor and an ORP sensor operatively connected to the metal chelant stream, the pH sensor configured to provide a pH value of the metal chelant stream and the ORP sensor configured to provide an ORP value of the metal chelant stream; and
a transmitter connected to the pH sensor and the ORP sensor, the transmitter configured to determine an rH value, based on the pH value and ORP value, of the metal chelant stream.

2. The system of claim 1, further comprising:
an integrated electrode including the pH sensor and ORP sensor.

3. The system of claim 1, wherein the metal chelant stream further comprises:
a metal chelant, metal chelants, ferric salts, ferrous salts, ferric chelants, ferrous chelants, nano-iron, colloidal iron, Fe-MGDA, HEME, organisms containing HEME, or a combination thereof.

4. The system of claim 1, wherein the oxidation unit comprises:
an oxidation agent injector configured to provide the oxidation stream to the oxidation unit at an oxidation stream rate;
an oxidation controller connected to the oxidating agent injector and operably connected to the transmitter, the oxidation controller configured to receive the rH value from the transmitter, and the oxidation provider controller configured to change the oxidation stream rate based on the rH value.

5. The system of claim 1, further comprising:
a pump connected to the metal chelant stream, the pump configured to provide the metal chelant stream to the reduction unit at a pump speed; and
a pump controller operatively connected to the pump and the transmitter, the pump controller configured to receive the rH value from the transmitter and the pump controller configured to change the pump speed based on the rH value.

6. The system of claim 1, wherein the sensor is operatively connected to the metal chelant stream between the reduction unit and the oxidation unit.

7. The system of claim 1, wherein the sensor is operatively connected to the metal chelant stream, the sensor being downstream of the oxidation unit and upstream of the reduction unit.

8. The system of claim 1, wherein the influent gas stream comprises hydrogen sulfide, hydrocarbon gas, carbon dioxide or any combination thereof.

9. The system of claim 1, wherein the reduction unit includes an eductor, co-current contactor, countercurrent contactor or co-current and countercurrent contactor configured to contact the influent gas stream with the metal chelant stream and release the treated gas stream separate from the metal chelant stream.

10. The system of claim 1, wherein the oxidation unit includes co-current bubble contactor or countercurrent packed tower.

11. The system of claim 4, wherein the oxidating agent injector is a blower configured to provide a gaseous oxidation stream to the oxidation unit or the oxidating agent injector is a pump configured to provide an aqueous oxidation stream to the oxidation unit.

12.-21. (canceled)

22. A method of operating a gas treatment system comprising:
operating a reduction oxidation unit including
a reduction unit configured to contact an influent gas stream with a metal chelant stream and release a treated gas stream separate from the metal chelant stream; and
an oxidation unit downstream of the reduction unit, the oxidation unit configured to contact an oxidation stream and the metal chelant stream;
circulating the metal chelant stream from the reduction unit to the oxidation unit and from downstream of the oxidation unit to the reduction unit;
measuring, via a pH sensor and an ORP sensor, a pH value and an ORP value of the metal chelant stream; and
determining an rH value, via a transmitter, operatively connected to the pH sensor and the ORP sensor, based on the pH value and ORP value, of the metal chelant stream.

23. The method of claim 22, further comprising:
using a pH and ORP electrode, including the pH sensor and ORP sensor, to measure the pH value and the ORP value of the metal chelant stream.

24. The method of claim 22, wherein measuring, via a pH sensor and an rH sensor, a pH value and an ORP value of the metal chelant stream further comprises:
measuring the pH value and the ORP value at a point within the metal chelant stream.

25. The method of claim 24, wherein measuring the pH value and the ORP value at a point within the metal chelant stream further comprises:
measuring, simultaneously, the pH value and the ORP value of the metal chelant stream.

26. The method of claim 22, further comprising:
using a pump to circulate, at a pump speed, the metal chelant stream from downstream of the oxidation unit to the reduction unit;
receiving the rH value, via a pump controller; and
changing the pump speed, via the pump controller, based on the rH value.

27. The method of claim 25, further comprising:
providing the oxidation stream to the oxidation unit at an oxidation stream rate; and
changing the oxidation stream rate on the rH value.

28. The method of claim 22, wherein circulating the metal chelant stream further comprises:
circulating the metal chelant stream including a metal chelant, metal chelants, ferric salts, ferrous salts, ferric chelants, ferrous chelants, nano-iron, colloidal iron, Fe-MGDA, HEME, organisms containing HEME, or a combination thereof.

29.-33. (canceled)
